(19) United States
(12) Patent Application Publication
(10) Pub. No.: US 2004/0015522 A1
(43) Pub. Date: Jan. 22, 2004

(54) Apparatus, system and method of providing a stackable private write file system

(75) Inventor: Eric Van Hensbergen, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/171,842

(22) Filed: Jun. 13, 2002

(51) Int. Cl. G06F 17/30

(52) U.S. Cl. 707/204

(57) ABSTRACT

A system, apparatus and method of allowing a client to modify copies of un-modifiable files are provided. When shared files are opened for modification by the client, a copy of the shared file is made and stored in the client's private file system. All modifications are made to this copy of the file. Subsequent read accesses to the file by the client will return the modified private copy. When other clients request access to a copy of the file, they will either receive the shared common version, or their own modified copy if they have made one. Files created by the client are always stored in the private file system. When files are opened for read, the private file system is always consulted first. If a copy of the file is not found in the private file system, the shared file systems are consulted in a prioritized fashion.

### BACKGROUND OF THE INVENTION

1. Technical Field

The present invention is directed to a method, system and apparatus for managing file systems. More specifically, the present invention is directed to a method, system and apparatus for providing a stackable private write file system.

2. Description of Related Art

In the past decade, there has been a trend toward shifting from mainframe or host-centric computing to a distributed client-server approach. This trend has continued to shift in recent years toward a network-centric or cluster computing. In a cluster computing environment, computer systems on a network share a common storage system. This common storage system is generically referred to as a network storage.

Network storages have been implemented using two predominant technologies: network attached storage (NAS) and storage area network (SAN). NAS grew out of the concept of using file servers as a means to manage files for clients on a network. To implement a NAS, storage devices are attached to a server, a NAS server. The NAS server is used to provide data to clients. The data may be provided to the clients on a file-by-file basis.

This configuration has greatly optimized the traditional client/server network model as management, security and data backup are centralized off the NAS server. If more storage space is needed, more NAS devices may simply be added to the network to expand the storage space. Furthermore, NAS servers often support multiple protocols (e.g., AppleTalk, SMB (server message block), NFS (network file system)) to facilitate file sharing across platforms.

SAN, on the other hand, grew around the concept of placing storage devices directly on a back-end network. This approach allows a many-to-many connection from servers to storage devices and from storage devices to other storage devices. Further, this approach provides all the benefits (e.g., scalability, availability and performance) associated with traditional networks to the storage network. In addition, data backups are done without affecting traffic on the regular network since the back-up traffic occurs over the back-end network.

Traditionally, each server or desktop in a SAN system was allocated a set of disks from a central pool. If a system administrator wanted to allocate more storage space to some of the computer systems, the administrator had to take storage disks away from one computer system and assign them to another. However, recent software advances have allowed file systems to be shared among all the computer systems on the network. Now, two or more computer systems may access the same files on the same set of disks. This provides quite an efficient use of space since users no longer need to maintain duplicate data. In addition, the ability to build clusters or other fault-tolerant systems has greatly increased.

As seen, both NAS and SAN allow clients to share files. Files are usually stored in file systems. A file system is a disk drive or a partition of a disk. Directories that have their own disk partition can be referred to as file systems whereas those that do not have their own disk partition are not file systems.

In UNIX systems, just as in most modern operating systems, file systems are organized in a hierarchical fashion. All user-available disk space is combined in a directory tree. The base of a file system in UNIX systems is the root directory, which is designated by a forward slash “/”. In UNIX systems, data media are not assigned drive letters, instead they are mounted in the file system. A directory provided for this (i.e., a mount point) serves for access to the content of the data media.

File systems can be mounted (connected to the directory tree) or dismounted (disconnected from the directory tree). A root file system is always mounted on the root directory when the system is running and cannot be dismounted. Root file systems contain directories such as /bin, /lib. These directories include executable files, library files etc. that are accessible to all clients on the network. Accordingly, none of the clients are allowed to modify any one of those files. Nonetheless, there are instances when a client may need to tailor some or all of those files to suit its own purpose.

Thus, it would be desirable to have a system, apparatus and method that would allow a client to make a private modification of an otherwise un-modifiable file. This private modification should only be viewable by the client that modified the file. This is particularly important in the case where there are diskless clients on the network as these clients use network storages to store data.

### SUMMARY OF THE INVENTION

The present invention provides a system, apparatus and method of allowing a client to modify copies of un-modifiable files. When shared files are opened for modification by the client, a copy of the shared file is made and stored in the client's private file system. All modifications are made to this copy of the file. Subsequent read accesses to the file by the client will return the modified private copy. When other clients request access to a copy of the file, they will either receive the shared common version, or their own modified copy if they had made one. Files created by a client are always stored in the private file system. When files are opened for read, the private file system is always consulted first. If a copy is not found in the private file system, the shared file systems are consulted in a prioritized fashion.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a file system hierarchy.

FIGS. 2, 3 and 4 depict file systems mounted on a root directory to form FIG. 1.

FIGS. 5 and 6 depict two file systems that are mounted on a root directory using the “mount” command to form FIG. 7.

FIGS. 8, and 9 depict two file systems mounted on a root directory using the “union mount” command to form FIG. 10.

FIGS. 11 and 12 depict two file systems mounted on a root directory using the “recursive union mount” command to form FIG. 13

FIG. 14 illustrates a stackable file system with different types of files residing on different physical disk partitions.

FIG. 15 is a flow chart of a process used to implement the invention.

FIGS. 16, 17, 18, 19, 20 and 21 what happens when the invention is used when creating a new file in a stackable private write file system.

FIGS. 22, 23, 24, 25 and 26 illustrate the result of modifying a shared file in a stackable private write file system.

FIG. 27 is an exemplary block diagram illustrating a distributed data processing system according to the present invention.

FIG. 28 is an exemplary block diagram of a server or client apparatus according to the present invention.

### DETAILED DESCRIPTION OF THE PREFERRED EMBODIMENT

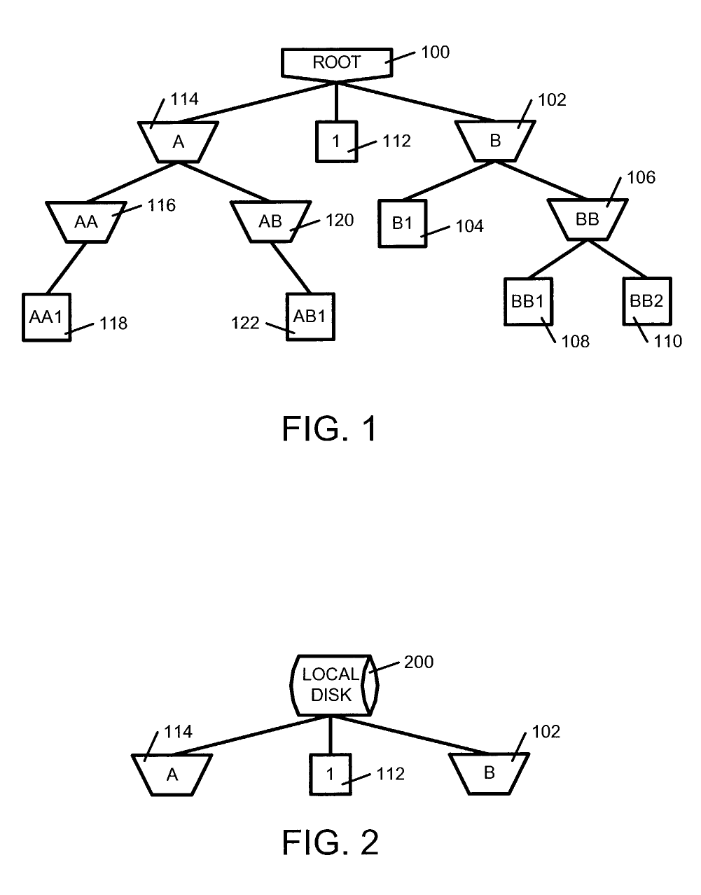

Turning to the figures, wherein like numbers denote like parts throughout, FIG. 1 depicts an exemplary block diagram illustrating a file system hierarchy. The base of the file system is root 100, which is a directory. Attached to root 100 are directories A 114 and B 102 and data object 1 112. Root 100 is a mount point. In UNIX-based systems, root 100 is usually a top level directory under system root “/” such as “/usr” or “/home”. In Windows-based systems, root 100 is typically a drive (i.e., C:).

Attached to directory A 114 are directories AA 116 and AB 120, which contain data objects AA1 118 and AB1 122, respectively. Likewise, attached to directory B 102 are data object B1 104 and directory BB 106, which itself contains data objects BB1 108 and BB2 110.

Directories A 114, B 102, AA 116, AB 120 and BB 106 may be represented as folders. As shown, these directories may contain data objects or other directories and form the hierarchy or tree of the file system. Data objects 1 112, AA1 118, AB1 122, B1 104, BB1 108 and BB2 110 may be documents, program executables, data of program executables etc.

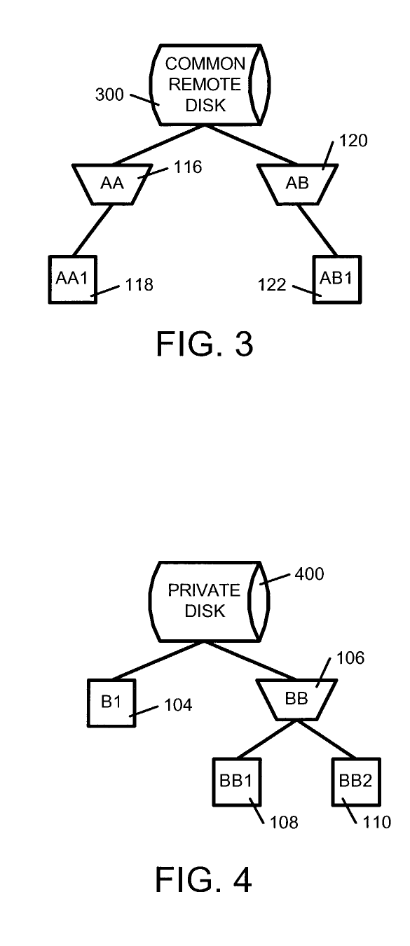

The file system in FIG. 1 may be made up of FIG. 2, FIG. 3 and FIG. 4. FIG. 2 may be a local disk 200 that contains directories A 114 and B 102 and data object 112. FIG. 3 may be a remote disk 300 that includes directories AA 116 and AB 120. Directory AA 16 may contain data object AA1 118 and directory AB may contain data object AB1 122. FIG. 4 may be a private disk 400 that contains data object B1 104 and directory BB 106. Directory BB 106 may contain data objects BB1 108 and BB2 110.

Local disk 200 of FIG. 2 may be mounted on root 100 of FIG. 1. Common disk 300 may be mounted on directory A 114 of FIG. 1 and private disk 400 may be mounted on directory B 102. To mount a file system, a command must be issued. The command must identify the disk or disk partition to be mounted and where it is to be mounted. For example, the command “mount CommonRemoteDisk /A” will mount the file system shown in FIG. 3 on mount point A 114 of FIG. 2. Likewise, the command “mount PrivateDisk /B” will mount the file system shown in FIG. 4 on mount point B 102 of FIG. 2. Here FIG. 2 will have already been mounted at root directory “/” to arrive at FIG. 1 when the two file systems are mounted. As shown in FIG. 1, when a file system is mounted at a mount point, the name of the storage device in which the file system is contained is replaced by the name of the directory on which it is mounted.

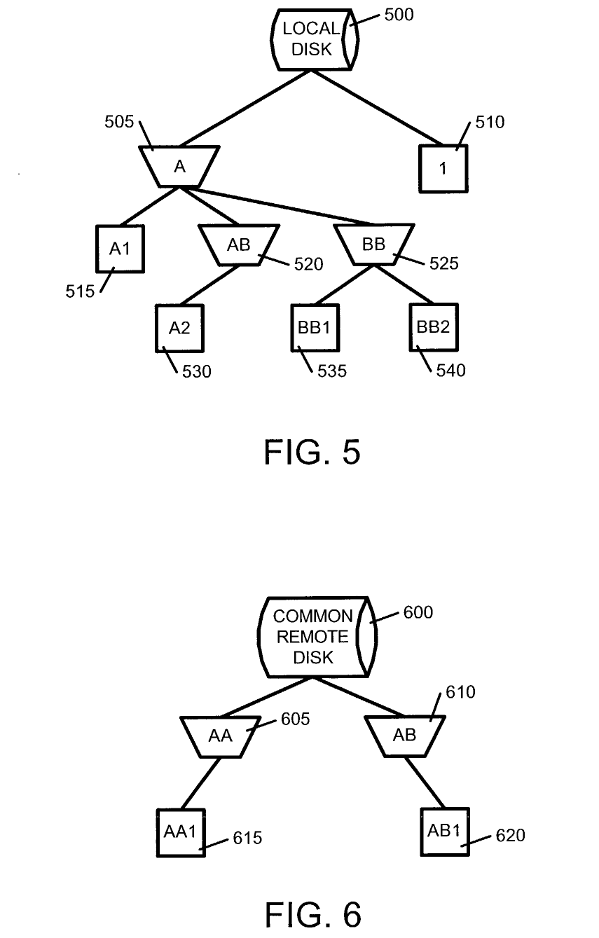

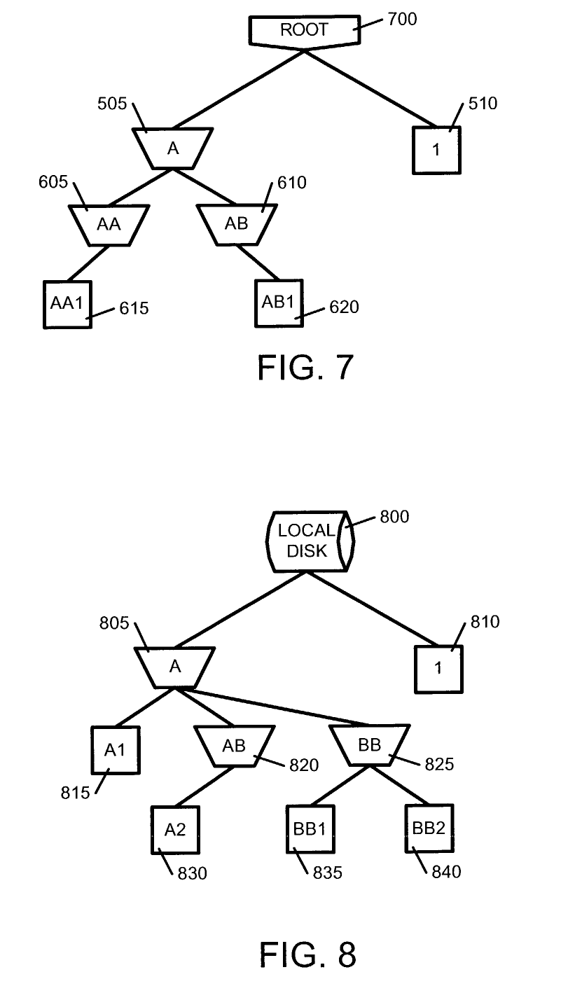

A plurality of file systems may be mounted at one mount point. However, depending on the particular mount command issued to mount a successive file system at a mount point, a previously mounted file system may not be accessible. For example, if a regular mount command is used to mount a second file system at a mount point, the first file system will not be accessible unless the second file system is first dismounted. If instead a “union mount” command is used, both file systems will be accessible. FIGS. 5, 6 and 7 illustrate what occurs when a second file system is mounted at a mount point using the mount command and FIGS. 8, 9 and 10 illustrate what occurs when a second file system is mounted at a mount point using the “union mount” command.

In FIG. 5 is shown a file system (local disk 500), which contains a directory A 505 and data object 1 510. In the directory A 505 are data object A1 515, directory AB 520 and directory BB 525. Directory AB 520 contains data object A2 530 and directory BB 525 contains data objects BB1 535 and BB2 540. In FIG. 7, the file system shown in FIG. 6 is mounted, using the mount command, at the mount point A 505 of FIG. 5. Consequently, portion of the tree at the mount point in FIG. 5 is completely replaced by the mounted file system.

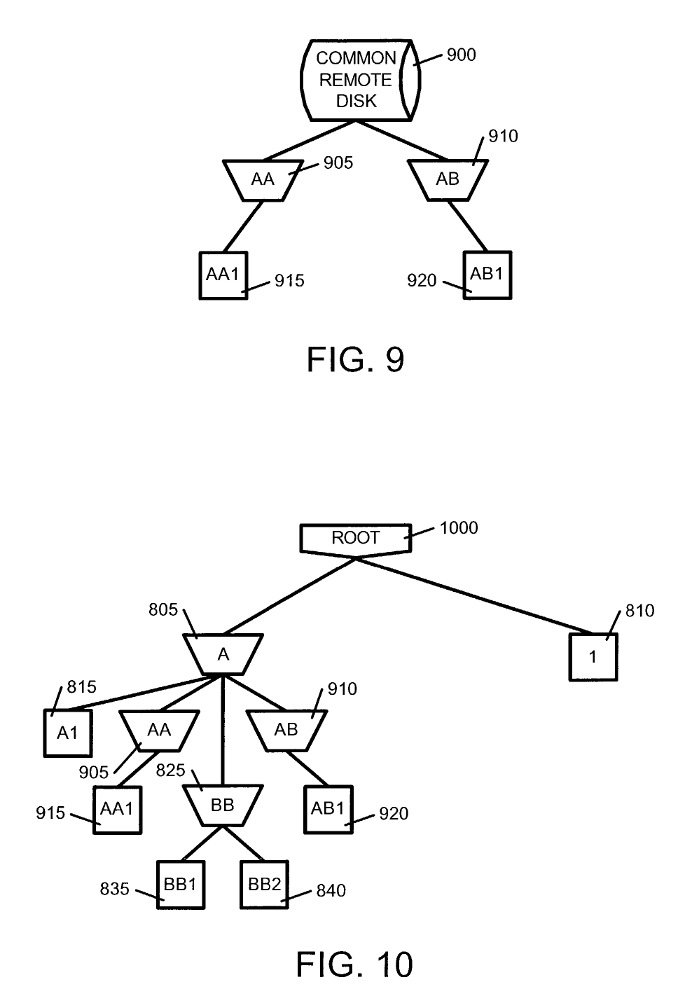

FIG. 8 illustrates a file system (local disk 800). The file system contains a directory A 805 and data object 1 810. In the directory A 805 are data object A1 815, directory AB 820 and directory BB 825. Directory AB 820 contains data object A2 830 and directory BB 825 contains data objects BB1 835 and BB2 840. In FIG. 10, the file system shown in FIG. 9 is mounted, using the “union mount” command, at the mount point A 805 of FIG. 8. Consequently, the portion of the file system in directory A 805 and the mounted file system are merged. However, contents of directories in the file system in FIG. 8 may be replaced by contents of directories of the mounted file system if the mounted file system and the file system in FIG. 8 contain the same directories at the same levels in the hierarchy. For example, data object A2 830, which is in directory AB 820, may be replaced by data object AB1 920 in directory AB 910 of FIG. 9 as shown in FIG. 10.

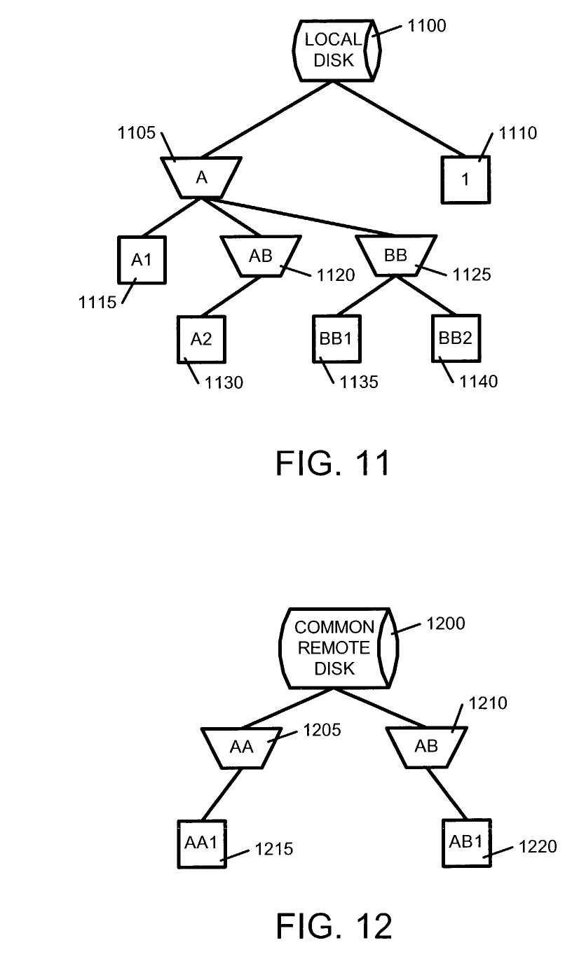

The present invention uses an extension of the “union mount” command called “recursive union mount”. When this command is used to mount a second file system at a mount point, hierarchies from the two trees or file systems are combined at all levels of the trees. Files are replaced only if they exist in both trees at the same node in the hierarchy. Directories are always merged. FIGS. 11, 12 and 13 illustrate this method of mounting file systems.

In FIG. 11 a file system (local disk 1100) is shown. The file system contains a directory A 1105 and data object 1 1110. In directory A 1105 are data object A1 1115, directory AB 1120 and directory BB 1125. Directory AB 1120 contains data object A2 1130 and directory BB 1125 contains data objects BB1 1135 and BB2 1140. In FIG. 13, the file system shown in FIG. 12 is mounted, using the recursive “union mount” command, at the mount point A 1105 of FIG. 11. Consequently, the portion of the file system in directory A 1105 and the mounted file system are merged. However, if the file system in FIG. 12 had a data object A2 under directory AB 1210, the data object A2 1130 in FIG. 11 would have been replaced by this data object.

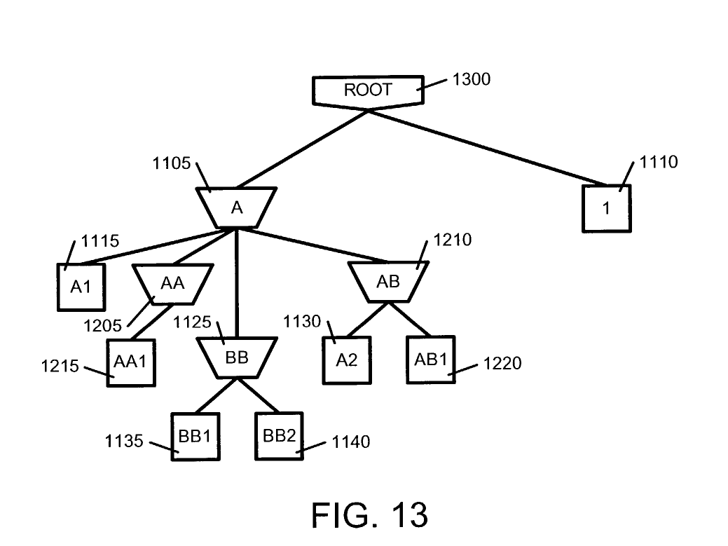

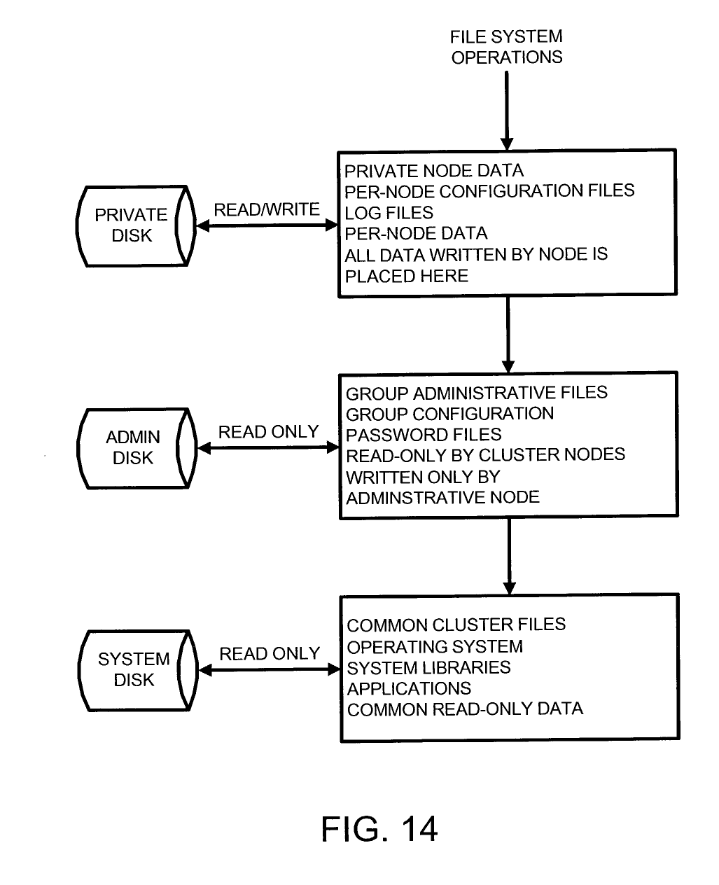

FIG. 14 illustrates a stackable private-write file system layout. The first file system to be mounted is the file system containing common cluster files such as operating system files, system library files, common read-only data files and application files. These files are usually on the system disk and are only read-only files. The second file system to be mounted, using the recursive “union mount” command, is the file system containing group administrative files such as group configuration files, password files, read-only by cluster nodes files and files that may only be written by a system administrator. These files are usually found on the administrative disk. The third file system to be mounted, again using the recursive “union mount” command, is the file system containing data that is private to the client system. This file system may contain all data file created by the client system (i.e., configuration files, log files, data files etc.). As will be explained later, the vertical arrows in FIG. 14 are used to illustrate the order in which the file systems in the stack are checked for a particular file when the file is being accessed.

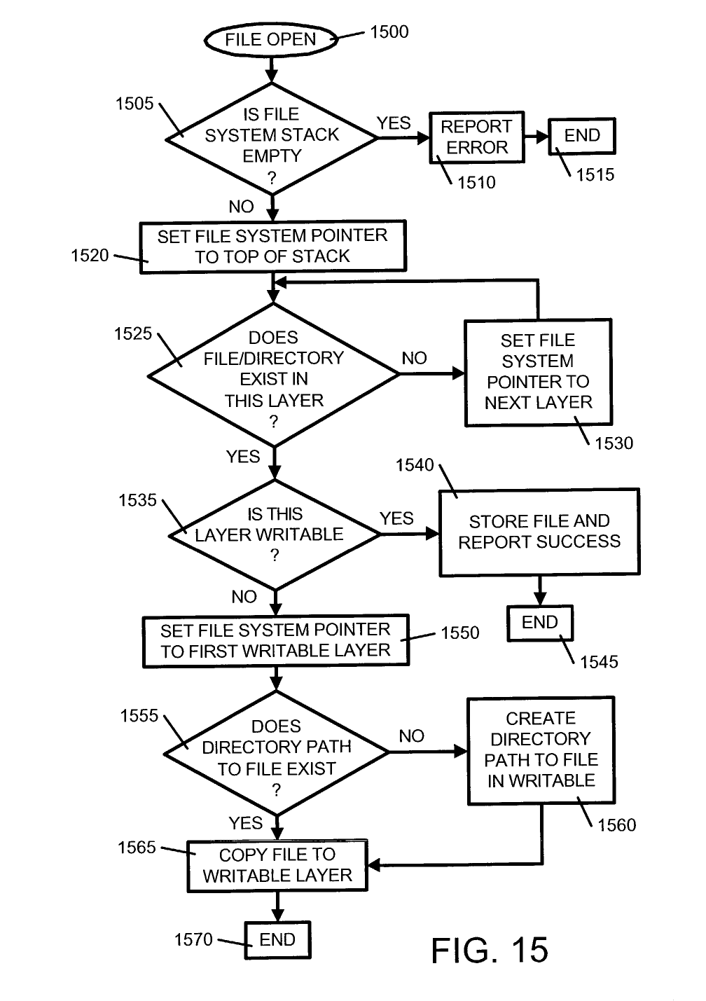

FIG. 15 is a flow chart of a process that may be used to allow a client system to make a private modification of otherwise un-modifiable files. When a file is open, a check is made to determine whether the file system stack is empty. If so, an error message is generated and the process ends (steps 1500-1515). If the file system stack is not empty, the file system pointer is set to the top of the stack and a check is made to determine whether a copy of the file exists in this layer. If not, the pointer is set to the next file system in the stack and another check is made to determine whether a copy of the file exists in this layer. This will continue until a copy of the file is found in one of the file systems in the stack (steps 1520-1530).

When a copy of the file is found in one of the file systems in the stack, a check will be made to determine whether the file system containing the copy of the file can be written into. If so, the opened file will be stored in the file system, presumably overwriting the existing copy. A success report will be generated and the process will end (steps 1535-1545). If the layer in which the copy of the file is located cannot be written into, then the file system pointer will be set to the first file that can be written into. Then a check is made to determine whether there exists a directory path to the file. If so the file is saved in the file system. If not, one is created before the file is saved in the file system (steps 1550-1570).

In the case where a file is being created, the file will not be found in any one of the file systems in the stack. Thus, the file will be stored in the top layer of the stack (i.e., the private disk of the client). Consequently, files created by the client are always stored in the client's private file system.

When files are opened for read accesses, the private file system is always consulted first. If a copy of the file is not found in the private file system, the next file system in the stack will then be consulted. As shown by the down arrows in FIG. 14, this will continue until a copy of the file is found in one of the file systems.

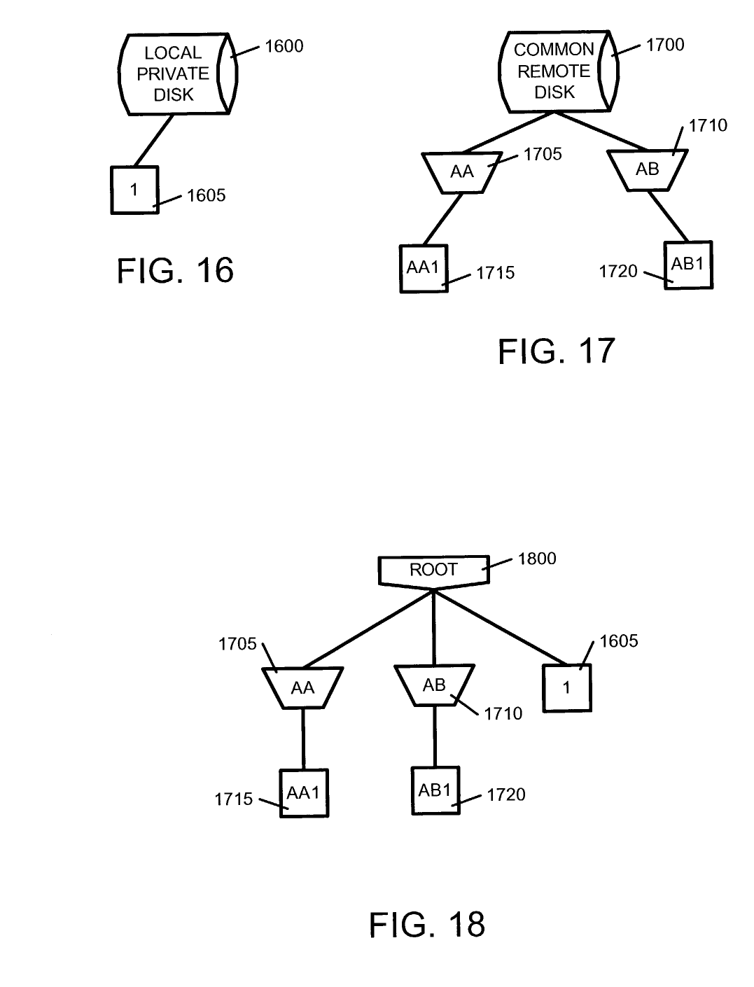

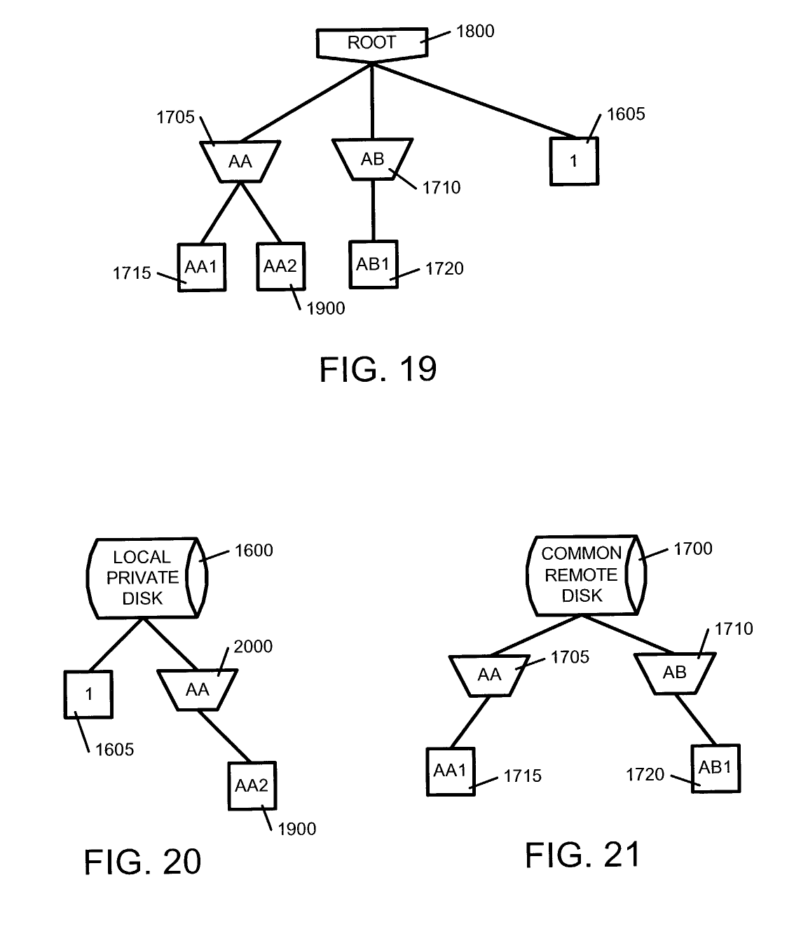

FIGS. 16-21 illustrate the result of creating a new file in a stackable private write file system. File system in FIG. 16 is the local private disk of a client and contains data object 1 1605. File system in FIG. 17 is a common remote disk and contains directories AA 1705 and AB 1710. Directory AA 1705 contains data object AA1 1715 and directory AB 1710 contains data object AB1 1720. After the client mounts the two file systems (i.e., FIGS. 16 and 17) to root file system 1800, it creates a new file or data object AA2 1900 in directory AA 1705. This file is shown in FIG. 19. The new file will be stored in the local private disk of FIG. 16 as shown in FIG. 20. In this case, a new directory AA 2000 will also be created in the local file system since the new file was created under that directory in FIG. 19. FIGS. 20 and 21 depict the original file systems (i.e., FIGS. 16 and 17) after having been dismounted from root file system 1800.

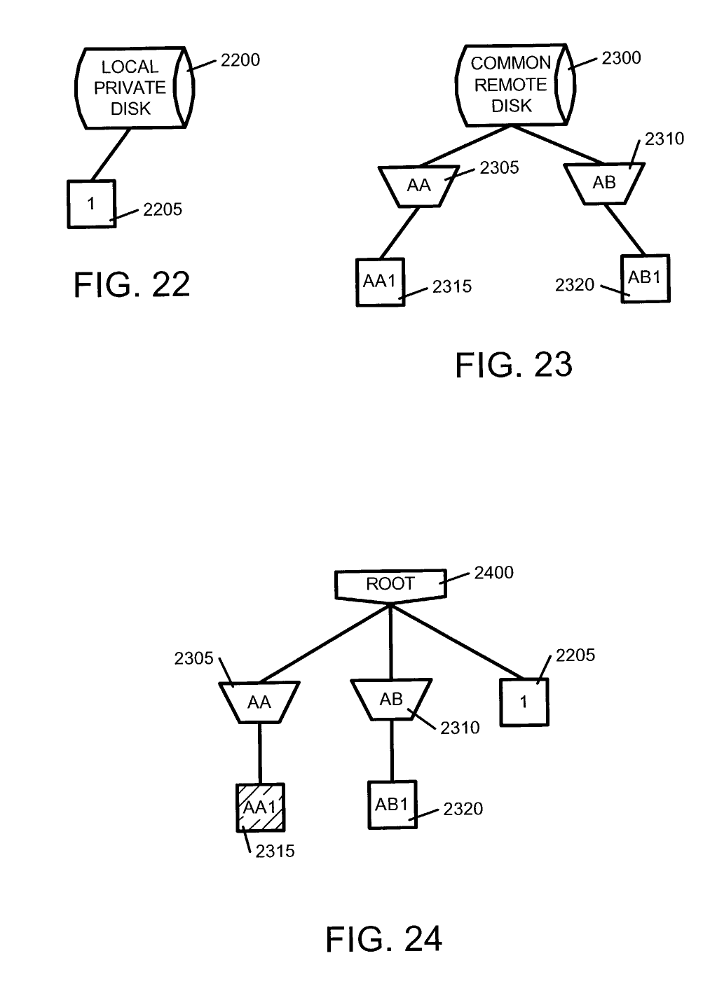

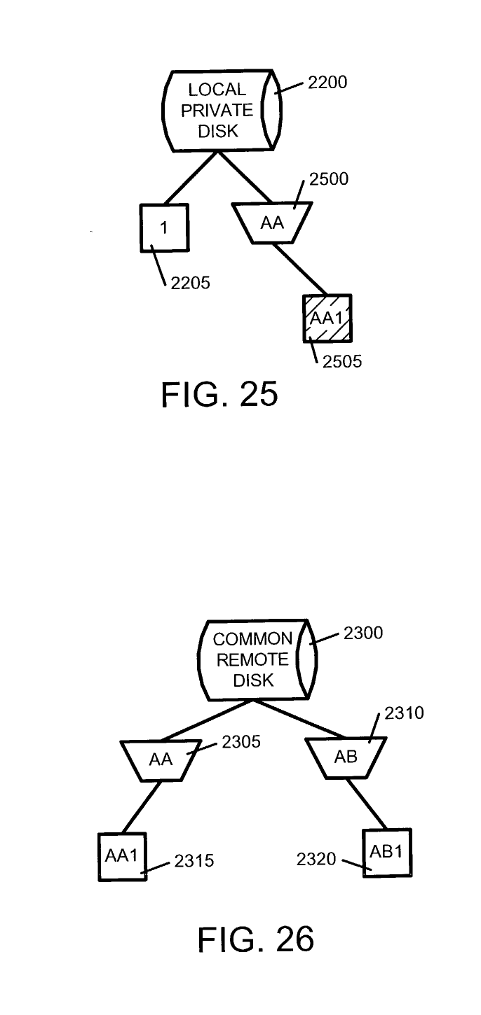

FIGS. 22-26 illustrate the result of modifying a shared file in a stackable private write file system. As before, file system in FIG. 22 is the local private disk of a client and contains data object 1 2205. File system in FIG. 23 is a common remote disk and contains directories AA 2305 and AB 2310. Directory AA 2305 contains data object AA1 2315 and directory AB 2310 contains data object AB1 2320. After the client mounts the two file systems (i.e., FIGS. 22 and 23) to root file system 24, it modifies data object AA1 2315 in directory AA 2305. The modified file will be stored in the local private disk of FIG. 22 as shown in FIG. 25. However, common remote disk 2300 will retain the original file (see FIG. 26).

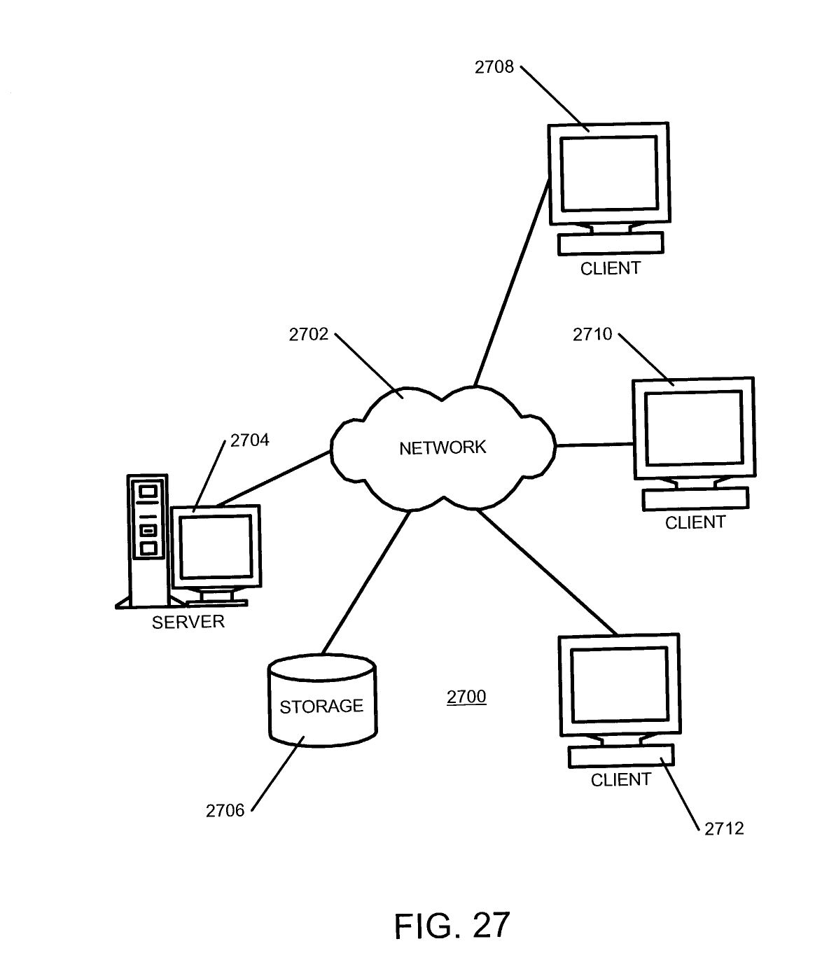

FIG. 27 depicts a pictorial representation of a network of data processing systems in which the present invention may be implemented. Network data processing system 2700 is a network of computers and contains a network 2702, which is the medium used to provide communications links between various devices and computers connected together within network data processing system 2700. Network 2702 may include connections, such as wire, wireless communication links, or fiber optic cables.

In the depicted example, server 2704 is connected to network 2702 along with storage unit 2706. In addition, clients 2708, 2710 and 2712 are connected to network 2702. These clients may be, for example, personal computers or network computers. In the depicted example, server 2704 provides data, such as boot files, operating system images, and applications to clients 2708, 2710 and 2712. Network data processing system 2700 may include additional servers, clients, and other devices not shown. In the depicted example, network data processing system 2700 is the Internet with network 2702 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 2700 also may be implemented as a number of different types of networks, such as for example, an intranet, a local area network (LAN), or a wide area network (WAN). FIG. 27 is intended as an example, and not as an architectural limitation for the present invention.

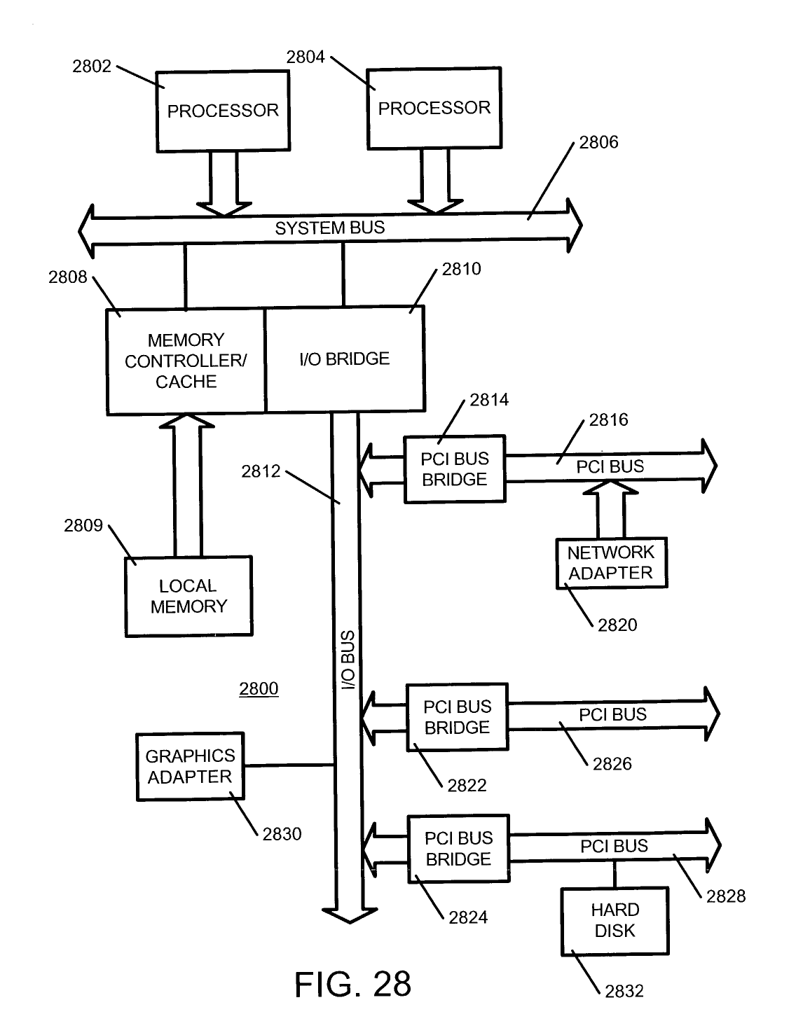

Referring to FIG. 28, a block diagram of a data processing system that may be implemented as a server or a client, such as server 2704 in FIG. 1, is depicted in accordance with a preferred embodiment of the present invention. Data processing system 2800 may be a symmetric multiprocessor (SMP) system including a plurality of processors 2802 and 2804 connected to system bus 2806. Alternatively, a single processor system may be employed. Also connected to system bus 2806 is memory controller/cache 2808, which provides an interface to local memory 2809. I/O bus bridge 2810 is connected to system bus 2806 and provides an interface to I/O bus 2812. Memory controller/cache 2808 and I/O bus bridge 2810 may be integrated as depicted.

Peripheral component interconnect (PCI) bus bridge 2814 connected to I/O bus 2812 provides an interface to PCI local bus 2816. A number of modems may be connected to PCI local bus 2816. Typical PCI bus implementations will support four PCI expansion slots or add-in connectors. Communications links to network computers 2708, 2710 and 2712 in FIG. 27 may be provided through network adapter 2820 connected to PCI local bus 2816 through add-in boards. Additional PCI bus bridges 2822 and 2824 provide interfaces for additional PCI local buses 2826 and 2828, from which additional network adapters may be supported. In this manner, data processing system 2800 allows connections to multiple network computers. A memory-mapped graphics adapter 2830 and hard disk 2832 may also be connected to I/O bus 2812 as depicted, either directly or indirectly.

Those of ordinary skill in the art will appreciate that the hardware depicted in FIG. 28 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 28 may be, for example, an IBM e-Server pSeries system, a product of International Business Machines Corporation in Armonk, N.Y., running the Advanced Interactive Executive (AIX) operating system or LINUX operating system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of storing a file in a file system, said file system being one of a plurality of file systems mounted at a common mount point to form a layered stack of file systems, the method comprising the steps of:
determining whether a copy of the file exists in any one of the file systems in the layered stack;
determining, if a copy of the file exists in one of the file systems, whether the file system in which the file exists can be written into; and
storing the file in the file system in which it exists if the file system can be written into.

2. The method of claim 1 further including the step of storing the file in a file system in the layered stack that can be written into if the file system in which the file exists cannot be written into.

3. The method of claim 2 further including the step of creating a directory path to the file, if one does not already exist, when storing the file.

4. The method of claim 3 wherein if a copy of the file does not exist in any one of the file systems in the layered stack, the file is stored in a file system in the layered stack that can be written into and a directory path to the file is created.

5. The method of claim 4 wherein the file system at the top layer of the layered stack of file systems is a private file system belonging to a user who is storing the file.

6. A method of opening a file in a file system for a read access, said file system being one of a plurality of file systems mounted at a common mount point to form a layered stack of file systems, the method comprising the steps of:
determining whether a copy of the file exists in the topmost layer of the stack; and
opening the file, if a copy of the file exists in the topmost layer of the stack.

7. The method of claim 6 wherein if the file does not exist in the topmost layer of the stack a determination is made as to whether the file exists in the next layer of the stack and to open the file if a copy exists therein.

8. The method of claim 7 wherein each successive layer is consulted to determine whether the file exists therein.

9. A computer program product on a computer readable medium for storing a file in a file system, said file system being one of a plurality of file systems mounted at a common mount point to form a layered stack of file systems, the computer program product comprising:
code means for determining whether a copy of the file exists in any one of the file systems in the layered stack;
code means for determining, if a copy of the file exists in one of the file systems, whether the file system in which the file exists can be written into; and
code means for storing the file in the file system in which it exists if the file system can be written into.

10. The computer program product of claim 9 further including code means for storing the file in a file system in the layered stack that can be written into if the file system in which the file exists cannot be written into.

11. The computer program product of claim 10 further including code means for creating a directory path to the file, if one does not already exist, when storing the file.

12. The computer program product of claim 11 wherein if a copy of the file does not exist in any one of the file systems in the layered stack, the file is stored in a file system in the layered stack that can be written into and a directory path to the file is created.

13. The computer program product of claim 12 wherein the file system at the top layer of the layered stack of file systems is a private file system belonging to a user who is storing the file.

14. A computer program product on a computer readable medium for opening a file in a file system for a read access, said file system being one of a plurality of file systems mounted at a common mount point to form a layered stack of file systems, the computer program product comprising:
code means for determining whether a copy of the file exists in the topmost layer of the stack; and
code means for opening the file, if a copy of the file exists in the topmost layer of the stack.

15. The computer program product of claim 14 wherein if the file does not exist in the topmost layer of the stack a determination is made as to whether the file exists in the next layer of the stack and to open the file if a copy exists therein.

16. The computer program product of claim 15 wherein each successive layer is consulted to determine whether the file exists therein.

17. An apparatus for storing a file in a file system, said file system being one of a plurality of file systems mounted at a common mount point to form a layered stack of file systems, the apparatus comprising:
means for determining whether a copy of the file exists in any one of the file systems in the layered stack;
means for determining, if a copy of the file exists in one of the file systems, whether the file system in which the file exists can be written into; and
means for storing the file in the file system in which it exists if the file system can be written into.

18. The apparatus of claim 17 further including means for storing the file in a file system in the layered stack that can be written into if the file system in which the file exists cannot be written into.

19. The apparatus of claim 18 further including means for creating a directory path to the file, if one does not already exist, when storing the file.

20. The apparatus of claim 19 wherein if a copy of the file does not exist in any one of the file systems in the layered stack, the file is stored in a file system in the layered stack that can be written into and a directory path to the file is created.

21. The apparatus of claim 20 wherein the file system at the top layer of the layered stack of file systems is a private file system belonging to a user who is storing the file.

22. An apparatus for opening a file in a file system for a read access, said file system being one of a plurality of file systems mounted at a common mount point to form a layered stack of file systems, the apparatus comprising:
means for determining whether a copy of the file exists in the topmost layer of the stack; and
means for opening the file, if a copy of the file exists in the topmost layer of the stack.

23. The apparatus of claim 22 wherein if the file does not exist in the topmost layer of the stack a determination is made as to whether the file exists in the next layer of the stack and to open the file if a copy exists therein.

24. The apparatus of claim 23 wherein each successive layer is consulted to determine whether the file exists therein.

25. A computer system for storing a file in a file system, said file system being one of a plurality of file systems mounted at a common mount point to form a layered stack of file systems, the computer system comprising:
at least one storage device for storing code data; and
at least one processor for processing the code data to determine whether a copy of the file exists in any one of the file systems in the layered stack, to determine, if a copy of the file exists in one of the file systems, whether the file system in which the file exists can be written into, and to store the file in the file system in which it exists if the file system can be written into.

26. The computer system of claim 25 wherein the code data is further processed to store the file in a file system in the layered stack that can be written into if the file system in which the file exists cannot be written into.

27. The computer system of claim 26 wherein the code data is further processed to create a directory path to the file, if one does not already exist, when storing the file.

28. The computer system of claim 27 wherein if a copy of the file does not exist in any one of the file systems in the layered stack, the file is stored in a file system in the layered stack that can be written into and a directory path to the file is created.

29. The computer system of claim 28 wherein the file system at the top layer of the layered stack of file systems is a private file system belonging to a user who is storing the file.

30. A computer system for opening a file in a file system for a read access, said file system being one of a plurality of file systems mounted at a common mount point to form a layered stack of file systems, the computer system comprising:
at least one storage device for storing code data; and
at least one processor for processing the code data to determine whether a copy of the file exists in the topmost layer of the stack, and to open the file, if a copy of the file exists in the topmost layer of the stack.

31. The computer system of claim 30 wherein if the file does not exist in the topmost layer of the stack a determination is made as to whether the file exists in the next layer of the stack and to open the file if a copy exists therein.

32. The computer system of claim 31 wherein each successive layer is consulted to determine whether the file exists therein.
